(19) United States
(12) Patent Application Publication
(10) Pub. No.: US 2025/0306300 A1
(43) Pub. Date: Oct. 2, 2025

(54) OPTICAL FIBER COUPLING STRUCTURE FOR PHOTONIC PACKAGE

(71) Applicant: Taiwan Semiconductor Manufacturing Co., Ltd., Hsinchu (TW)

(72) Inventors: Ji Cui, Bolingbrook, IL (US); Shih-Hao Tseng, Hsinchu (TW); Jiun Yi Wu, Zhongli City (TW); Shih Wei Liang, Taichung City (TW); Chih-Ming Ke, Hsinchu (TW); Jia-Rui Hu, Taichung City (TW); Chen-Hua Yu, Hsinchu (TW)

(21) Appl. No.: 18/731,752

(22) Filed: Jun. 3, 2024

Related U.S. Application Data
(60) Provisional application No. 63/570,300, filed on Mar. 27, 2024.

(51) Int. Cl. G02B 6/42

(52) U.S. Cl. CPC G02B 6/4214

(57) ABSTRACT

A structure includes an upper silicon structure that includes a recess in a first side of the upper silicon structure, wherein the recess has a sloped sidewall; a lower silicon structure that includes a lens recessed in a first side of the lower silicon structure, wherein the first side of the upper silicon structure is bonded to the first side of the lower silicon structure, wherein the sloped sidewall of the upper silicon structure is vertically aligned with the lens of the lower silicon structure; and a waveguide structure within the recess, wherein the waveguide structure is optically coupled to the lens by the sloped sidewall.

### PRIORITY CLAIM AND CROSS-REFERENCE

This application claims the benefit of U.S. Provisional Application No. 63/570,300, filed on Mar. 27, 2024, which application is hereby incorporated herein by reference.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Improvements in each of these long-range optical components and short-range electrical components are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1, 2, 3, 4, 5, 6, 7, 8, 9, 10, 11, and 12 illustrate cross-sectional views of intermediate steps in the formation of a fiber coupling structure, in accordance with some embodiments.

FIGS. 13, 14, and 15 illustrate cross-sectional views of intermediate steps in the formation of a fiber coupling structure, in accordance with some embodiments.

FIGS. 16, 17, 18, and 19 illustrate cross-sectional views of intermediate steps in the formation of a fiber coupling structure, in accordance with some embodiments.

FIG. 20 illustrates a cross-sectional view of a photonic system, in accordance with some embodiments.

FIGS. 21, 22, 23, 24, and 25 illustrate cross-sectional views of intermediate steps in the formation of a fiber coupling structure, in accordance with some embodiments.

FIGS. 26 and 27 illustrate cross-sectional views of intermediate steps in the formation of a multi-fiber coupling structure, in accordance with some embodiments.

FIG. 28 illustrates a cross-sectional view of a multi-fiber coupling structure, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments are described herein in which silicon mirrors are formed to redirect optical signals as part of a fiber coupling structure that couples optical signals between an optical fiber and a photonic component. The reflective silicon surfaces may be formed using semiconductor processing techniques, and may have a low roughness and a high angle precision, which can result in improved optical coupling. The reflective silicon surfaces described herein may be optically coupled to optical fibers or waveguides within the fiber coupling structures. The embodiments described herein, however, are intended to be illustrative and are not intended to be limiting. Rather, the ideas presented may be implemented in a wide variety of embodiments, and all such embodiments are fully intended to be included within the scope of the disclosure.

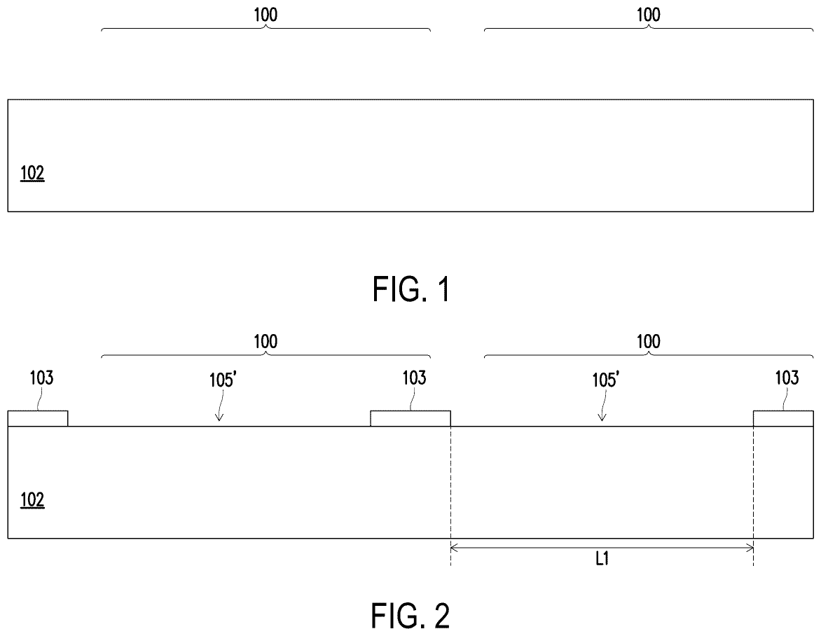

FIGS. 1-6 illustrate cross-sectional views of intermediate steps in the formation of a mirror structure 100 (see FIG. 6) of a fiber coupling structure 200 (see FIG. 12), in accordance with some embodiments. In some embodiments, multiple mirror structures 100 are formed on the same substrate 102, which then may be singulated into individual mirror structures 100 (see FIG. 6). Accordingly, FIG. 1 shows example regions 100 of the substrate 102 in which mirror structures 100 are subsequently formed. In other embodiments, multiple fiber coupling structures 200 are formed on the substrate 102, which is then singulated into individual fiber coupling structures 200. In some embodiments, the substrate 102 may be a silicon substrate, such as a silicon wafer, a buried oxide (BOX) silicon wafer, or the like. The mirror structures 100 described for FIGS. 1-6 are examples, and may have other dimensions, other feature sizes, other feature arrangements, or other configurations in other embodiments.

In FIG. 2, a hard mask 103 is formed over the substrate 102 and patterned, in accordance with some embodiments. The hard mask 103 may be formed by depositing a mask layer over the substrate 102 and then patterning the mask layer using suitable photolithography and etching techniques. The mask layer may include one or more layers of, for example, silicon nitride, silicon oxynitride, photoresist, the like, or a combination thereof. The material of the mask layer may be deposited using a suitable technique, such as Chemical Vapor Deposition (CVD), Physical Vapor Deposition (PVD), Atomic Layer Deposition (ALD), spin-on, the like, or a combination thereof. After patterning, the remaining portions of the mask layer form the hard mask 103. The pattern of the hard mask 103 includes openings 105′ that expose the substrate 102. In some embodiments, the openings 105′ may have a length L1 that is in the range of about 500 μm to about 20000 μm or have a width that is in the range of about 1000 μm to about 13000 μm, though other dimensions are possible.

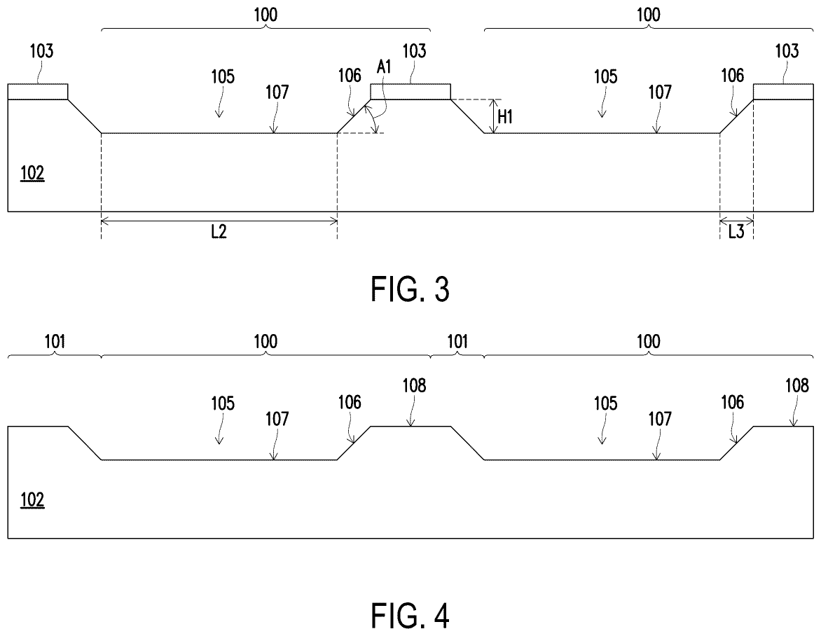

In FIG. 3, an etching process is performed to extend the openings 105′ and form recesses 105 in the substrate 102, in accordance with some embodiments. The patterned hard mask 103 is used as an etch mask during the etching process. In some embodiments, the etching process includes one or more anisotropic etching steps, which may include wet etching steps and/or dry etching steps. In some embodiments, the anisotropic etching process may be controlled to etch crystalline planes at different rates such that the recesses 105 have flat bottom surfaces 107 and sloped or inclined sidewall surfaces 106. For example, in some embodiments, the sidewall surfaces 106 of the recesses 105 may be (110) crystalline planes. In some cases, the bottom surfaces 107 may be substantially parallel to the top surface of the substrate 102, and the sidewall surfaces 106 may have an angle A1 of approximately 45° with respect to the bottom surfaces 107. For example, the angle A1 may be in the range of about 42.5° to about 47.5°, though other angles are possible. In some cases, anisotropically etching along crystalline planes may result in smoother or more planar sidewall surfaces 106. For example, in some cases, the sidewall surfaces 106 may have a roughness that is less than about 10 nm. Smooth sidewall surfaces 106 having an angle A1 of about 450 as described herein can be utilized as reflective surfaces in fiber coupling structures 200, described in greater detail below.

In some embodiments, a bottom surface 107 may have a length L2 that is in the range of about 500 μm to about 20000 μm or a width that is in the range of about 1000 μm to about 13000 μm, though other dimensions are possible. The length L2 of the bottom surfaces 107 is less than the length L1 of the top of the recesses 105. In some embodiments, a sidewall surface may have a height H1 that is in the range of about 50 μm to about 300 μm or a length L3 that is in the range of about 50 μm to about 300 μm, though other dimensions are possible. The height H1 may be approximately the same as a depth of the recess 105, in some cases. The height H1 may be approximately the same as the length L3, in some cases. In some cases, the height H1 may be sufficient such that the sidewall surface 106 is large enough to reflect all optical signals impinging on it (e.g. from an optical fiber 210).

In some embodiments, the etching process may include a wet etching process using a wet etching mixture comprising potassium hydroxide (KOH), tetramethylammonium hydroxide (TMAH), additives, surfactants, or the like. In some embodiments, the etching process may be performed at a process temperature that is in the range of about 1.0° C. to about 110° C., though other temperatures are possible. In some embodiments, the etching process may be performed for between about 10 minutes and about 30 hours, though other durations are possible. In some cases, the length L2, the length L3, and the height H1 may be controlled by controlling the duration of a timed etching process. Other etchants or etching parameters are possible.

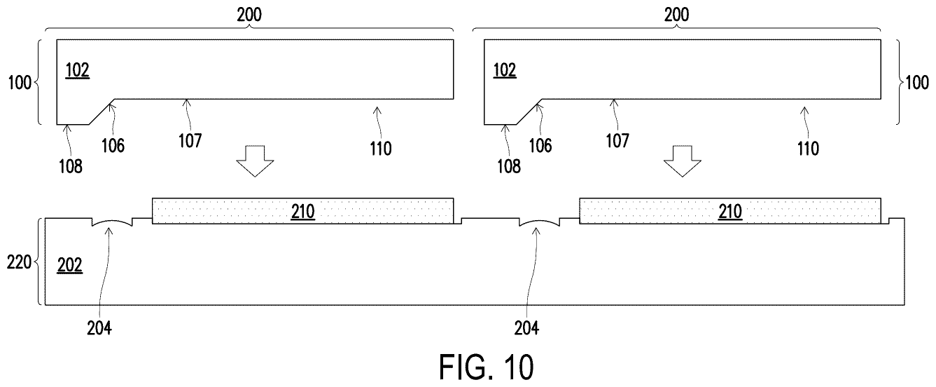

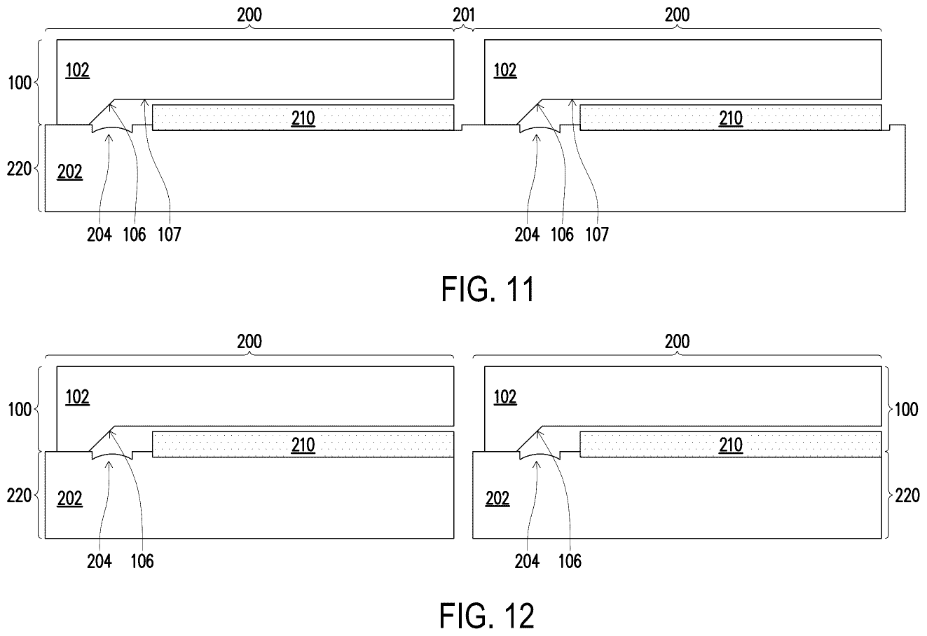

In FIG. 4, the hard mask 103 is removed, in accordance with some embodiments. The hard mask 103 may be removed using a suitable etching process, such as an etching process that selectively etches the material of the hard mask 103 faster than the material of the substrate 103. In some cases, an ashing process or the like may be used to remove the hard mask 103. In some embodiments, a planarization process, such as a chemical mechanical polishing (CMP) process or a grinding process, may be utilized. Removing the hard mask 103 exposes top surfaces 108 of the substrate 102 that were covered by the hard mask 103. These top surfaces 108 may be subsequently utilized for bonding a mirror structure 100 to a lens structure 220 (see FIGS. 10-11), and thus may also be referred to as “bonding surfaces 108” herein. Also shown in FIG. 4 are singulation regions 101, which are regions of the substrate 102 that are removed during singulation of the mirror structures 100. In this manner, the singulation regions 101 may also be considered scribe regions or the like. As shown in FIG. 4, the singulation regions 101 may overlap some sidewall surfaces 106 of recesses 105, in some embodiments. In some cases, the singulation regions 101 may also overlap portions of bottom surfaces 107.

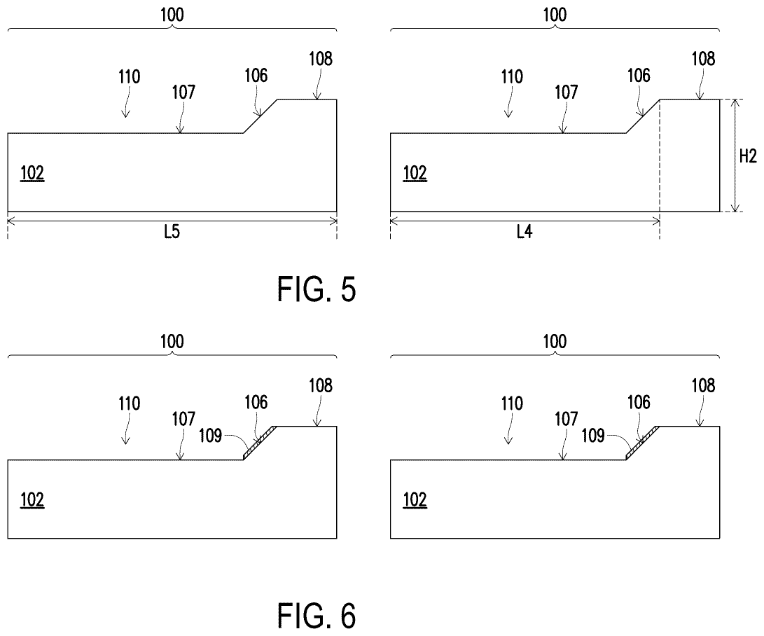

In FIG. 5, a singulation process is performed to singulate the substrate 102 into individual mirror structures 100, in accordance with some embodiments. The singulation process may include, for example, a mechanical sawing process, a laser sawing process, a plasma sawing process, an etching process, the like, or a combination thereof. The singulation process is performed in the singulation regions 101, and may fully or partially remove the singulation regions 101. The singulation process may remove portions of the recesses 105, with the remaining portions of the recesses 105 referred to herein as “mirror recesses 110” or “lateral recesses 110.” In some embodiments, the singulation process removes some sidewall surfaces 106 such that the mirror recesses 110 extend to the edges of the mirror structures 100. In this manner, a mirror recess 110 may have a laterally extending portion defined by a bottom surface 107 and a sidewall portion defined by a sidewall surface 106. Accordingly, the sidewall surface 106 of a mirror recess 110 may be considered a “mirror surface,” a “reflecting surface,” or the like. In some embodiments, a mirror recess 110 may have a length L4 that is in the range of about 400 μm to about 18000 μm, though other lengths are possible. In some embodiments, a mirror structure 100 has a height H2 that is in the range of about 300 μm to about 500 μm or a length L5 that is in the range of about 1000 μm to about 3.0 mm, though other dimensions are possible. In some cases, a height H2 greater than about 300 μm may reduce deformation or warping during subsequent processing.

In some embodiments, one or more reflection layers 109 are deposited over the sidewall surfaces 106 of the mirror structures 100, as shown in FIG. 6. The reflection layers 109 may comprise one or more layers that enhance or modify the reflective properties of the sidewall surfaces 106. For example, the reflection layers 109 may comprise one or more metal layers and/or one or more dielectric layers. A metal reflection layer 109 may comprise, for example, gold or other suitable metals. A dielectric reflection layer 109 may comprise, for example, one or more layers of silicon oxide, silicon nitride, silicon oxynitride, or the like. Other materials or combinations of materials are possible. The reflection layers 109 may be deposited using suitable techniques, such as CVD, PVD, ALD, or the like. The reflection layers 109 may be deposited only on the sidewall surfaces 106, as shown in FIG. 6, but in other embodiments, the reflection layers 109 may also be deposited on the bottom surfaces 107 and/or the bonding surfaces 108. The reflection layers 109 may be deposited at any suitable step, such as after any of the process steps shown in FIGS. 3-5. The reflection layers 109 are optional, and are not shown in subsequent figures.

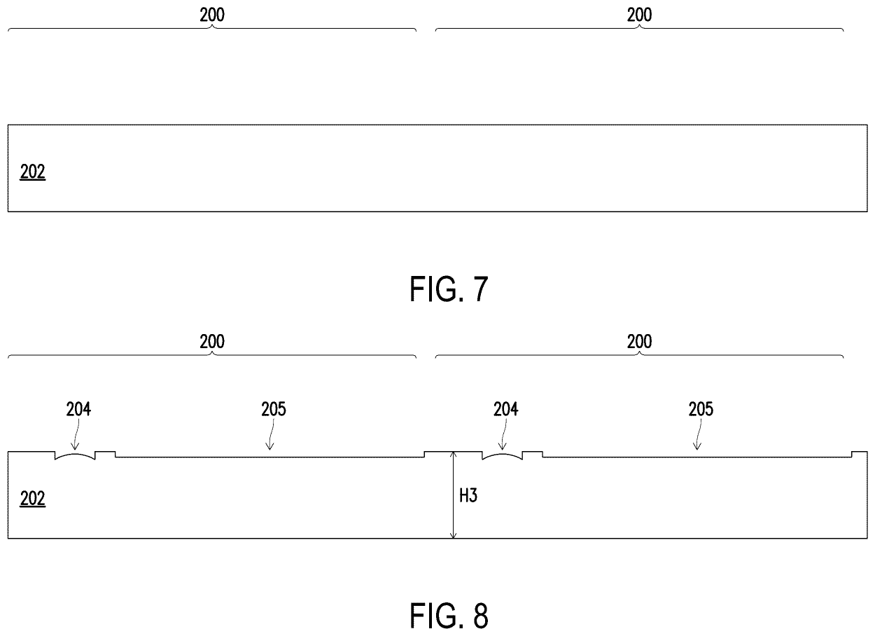

FIGS. 7 through 15 illustrate cross-sectional views of intermediate steps in the formation of fiber coupling structures 200, in accordance with some embodiments. In some embodiments, multiple fiber coupling structures 200 are formed on the same substrate 202, which then may be singulated into individual fiber coupling structures 200 (see FIG. 15). Accordingly, FIG. 7 shows example regions 200 of the substrate 202 in which fiber coupling structures 200 are subsequently formed. In some embodiments, the substrate 202 may be a silicon substrate, such as a silicon wafer, a buried oxide (BOX) silicon wafer, a substrate similar to the substrate 102, or the like. In other embodiments, the substrate 202 may be a glass substrate or the like. The fiber coupling structures 200 described for FIGS. 7-15 are examples, and may have other dimensions, other feature sizes, other feature arrangements, or other configurations in other embodiments.

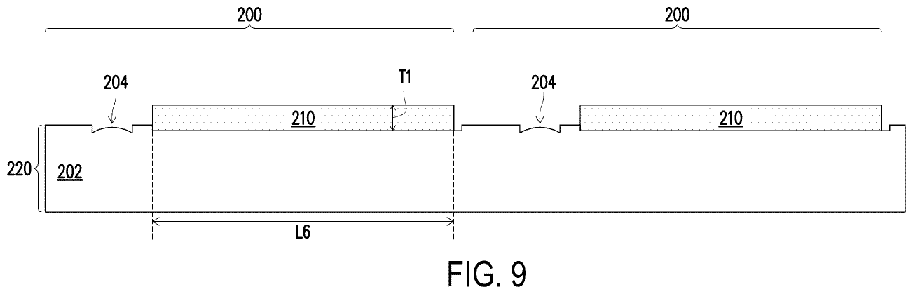

In FIG. 8, lenses 204 and grooves 205 are formed in the top surface of the substrate 202, in accordance with some embodiments. The lenses 204 are structures formed in the top surface of the substrate 202 that may focus, collimate, re-shape, or otherwise modify optical signals (e.g., light) to facilitate the transmission of those optical signals, described in greater detail below. The grooves 205 are grooves (e.g., recesses, trenches, or the like) in the top surface of the substrate 202 that support and align subsequently attached optical fibers 210 (see FIG. 9). The lenses 204 and grooves 205 may be formed using suitable photolithography and etching techniques. For example, the lenses 204 and grooves 205 may be formed using one or more wet etching steps and/or one or more dry etching steps, which may include isotropic and/or anisotropic etches. In this manner, the lenses 204 are recessed into the top surface of the substrate 202. The lenses 204 and grooves 205 may be formed sequentially or simultaneously. In some embodiments, the substrate 202 may have a height H3 that is in the range of about 300 μm to about 1100 μm, though other heights are possible. In some cases, a height H3 greater than about 300 μm may reduce deformation or warping during subsequent processing.

In FIG. 9, optical fibers 210 are placed in the grooves 205, in accordance with some embodiments. The optical fibers 210 may be secured by the grooves 205. The grooves 205 may also facilitate the optical alignment of the optical fibers 210 to reflective sidewall surfaces 106 (see FIG. 12). In some cases, an adhesive, an optical glue, or the like (not illustrated) may be used to attach the optical fibers 210 to the substrate 202. The adhesive or optical glue may be deposited before or after placement of the optical fibers 210 in the grooves 205. In some embodiments, the optical fibers 210 have at thickness T1 in the range of about 50 μm to about 300 μm or a length L6 in the range of about 500 μm to about 2.0 mm, though other dimensions are possible. In some cases, the regions of the substrate 202 with lenses 204 and optical fibers 210 may be referred to herein as lens structures 220. Accordingly, multiple lens structures 220 may be formed on the same substrate 202.

In FIGS. 10 and 11, mirror structures 100 are attached to the substrate 202, in accordance with some embodiments. FIG. 10 shows the mirror structures 100 prior to attachment, and FIG. 11 shows the mirror structures 100 after attachment. In some embodiments, the bonding surfaces 108 of the mirror structures 100 are attached to top surfaces of the substrate 202. The bonding surfaces 108 may be attached using fusion bonding (e.g., direct bonding), an adhesive, or the like. For example, in some embodiments, a fusion bonding process may be initiated by activating the bonding surfaces 108 of the mirror structures and corresponding bonding surfaces of the lens structures 220, which can facilitate bonding of the bonding surfaces. Activating the bonding surfaces may comprise, for example, a dry treatment, a wet treatment, a plasma treatment, exposure to an inert gas plasma, exposure to H₂, exposure to N₂, exposure to O₂, combinations thereof, or the like. For embodiments in which a wet treatment is used, an RCA cleaning process may be used, for example. In other embodiments, the activation process may comprise other types of treatments. After the activation process, the mirror structures 100 are aligned and placed into physical contact with the lens structures 220. The mirror structures 100 and the lens structures 220 may then be subjected to a thermal treatment and contact pressure to bond respective bonding surfaces together. In some embodiments, the resulting bonded structure is subsequently baked, annealed, pressed, or otherwise treated to strengthen or finalize the bonds. In this manner, the mirror structures 100 may be bonded to the lens structures 220 using chip-to-wafer bonding techniques or the like. This is an example, and other bonding or attachment processes are possible.

In some embodiments, after attaching the mirror structures 100, a gap may be present between the optical fibers 210 and the bottom surfaces 107 of the mirror structures 100, as shown in FIG. 11. In other embodiments, the bottom surfaces 107 may physically contact the optical fibers 210. In some embodiments, an optical glue or other optical material (not shown) may be deposited between the lens structures 220 and the mirror structures 100. The mirror structures 100 may be aligned to the lens structures 220 such that optical signals (e.g. light) passing through an optical fiber 210 is reflected by the corresponding sidewall surface 106 into the corresponding lens 204. Accordingly, a sidewall surface 106 may be vertically aligned to a lens 204 and laterally aligned to an optical fiber 210. As shown in FIG. 11, singulation regions 201 separate adjacent regions 200 in which fiber coupling structures 200 are formed.

In FIG. 12, a singulation process is performed to singulate the bonded structure into individual fiber coupling structures 200, in accordance with some embodiments. Accordingly, each fiber coupling structure 200 may comprise a mirror structure 100 bonded to a lens structure 220, in some embodiments. The singulation process may include, for example, a mechanical sawing process, a laser sawing process, a plasma sawing process, an etching process, the like, or a combination thereof. The singulation process is performed in the singulation regions 201, and may fully or partially remove the singulation regions 201. The singulation process removes portions of the substrate 202 and may remove portions of mirror structures 100, in some cases. The singulation process may remove portions of the grooves 205, in some cases. After singulation, the optical fibers 210 may be approximately coterminous with sidewalls of the fiber coupling structures 200, or may be offset from sidewalls of the fiber coupling structures 200. After singulation, a mirror structure 100 may have a length that is smaller than, about the same as, or greater than a length of the underlying lens structure 220. This is an example, and other processes of forming a fiber coupling structure 200 are possible.

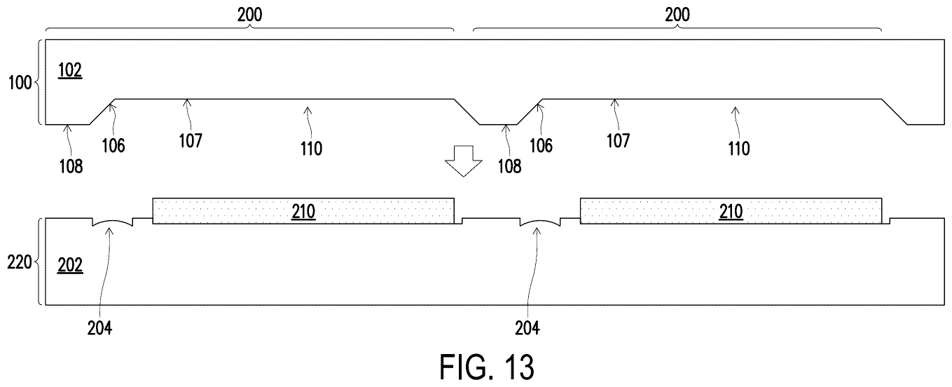

In other embodiments, the mirror structures 100 are not singulated before attachment to the lens structures 220. In other words, the substrate 102 may be attached to the substrate 202 prior to singulation. As an example, FIGS. 13-15 illustrate intermediate steps in the formation of fiber coupling structures 200, in accordance with some embodiments. FIG. 13 shows the mirror structures 100 prior to attachment, in which the mirror structures 100 are unsingulated, similar to FIG. 4.

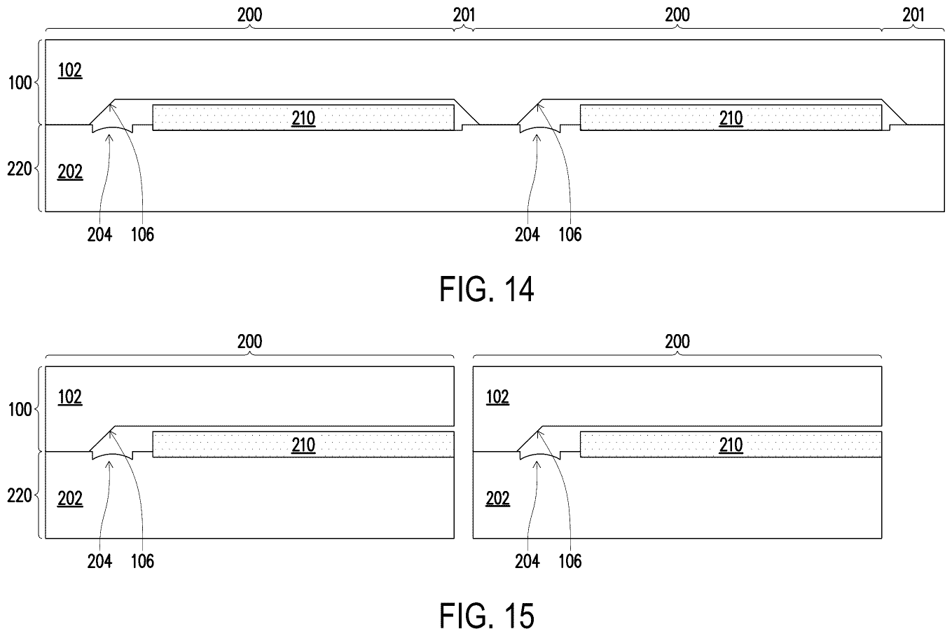

FIG. 14 illustrates the mirror structures 100 after alignment, placement, and attachment to the lens structures 220, in accordance with some embodiments. The substrate 102 may be attached to the substrate 202 using fusion bonding (e.g., direct bonding), an adhesive, or the like. For example, the substrate 102 may be aligned to the substrate 202 and bonded using fusion bonding techniques similar to those described for FIGS. 10-11. In this manner, the mirror structures 100 may be bonded to the lens structures 220 using wafer-to-wafer bonding techniques or the like. This is an example, and other bonding or attachment processes are possible. As shown in FIG. 14, the bonded structure comprises regions 200 in which fiber coupling structure 200 are formed that are separated by singulation regions 201.

In FIG. 15, a singulation process is performed to singulate the bonded structure into individual fiber coupling structures 200, in accordance with some embodiments. The singulation process may be similar to the singulation processes described for FIG. 12. After singulation, a mirror structure 100 may have a length that is smaller than, about the same as, or greater than a length of the underlying lens structure 220. In some embodiments, sidewalls of a mirror structure 100 and the underlying lens structure 220 may be coplanar.

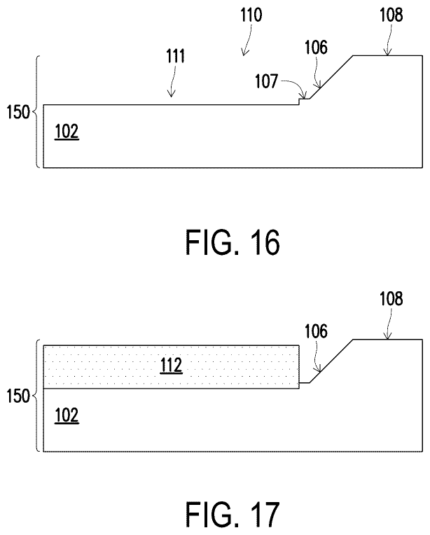

FIGS. 16 through 19 illustrate intermediate steps in the formation of a fiber coupling structure 250, in accordance with some embodiments. The fiber coupling structure 250 is similar to the fiber coupling structure 200 described previously, except that an optical fiber 112 is initially attached to a mirror structure 150 rather than to a lens structure 222. FIG. 16 illustrates a mirror structure 150, in accordance with some embodiments. The mirror structure 150 is similar to the mirror structure 100, except that a groove 111 is formed in the bottom surface 107 of the recess 110. The groove 11 may be shaped to secure an optical fiber 112, and may be formed using suitable photolithography and etching techniques. In FIG. 17, an optical fiber 112 is attached to the mirror structure 150, in accordance with some embodiments. The optical fiber 112 is placed into the groove 111, and may be attached using an adhesive, optical glue, or the like.

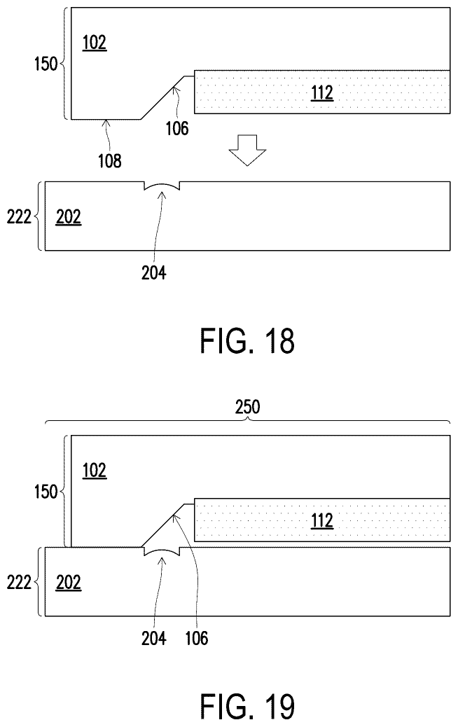

In FIGS. 18 and 19, the mirror structure 150 is attached to a lens structure 222, in accordance with some embodiments. The lens structure 222 is similar to the lens structure 220, except that a groove is not formed in the substrate 202 of the lens structure 222. In other embodiments, a recess or groove may be formed in the substrate 202 of the lens structure 222 to accommodate the optical fiber 112 after attachment. The mirror structure 150 may be attached to the lens structure 222 using fusion bonding, an adhesive, or the like. After attaching the mirror structure 150 to the lens structure 222, a gap may be present between the optical fiber 112 and the substrate 202. In other embodiments, the optical fiber 112 may physically contact the substrate 202. This is an example, and other configurations or process steps are possible.

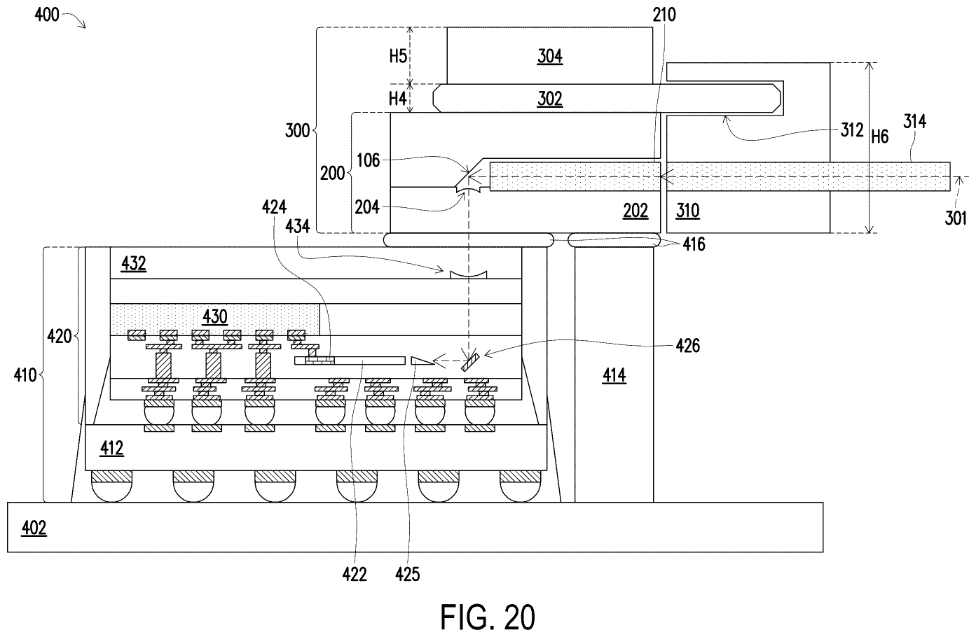

FIG. 20 illustrates a photonic system 400 comprising a fiber coupling structure 200, in accordance with some embodiments. The fiber coupling structure 200 shown in FIG. 20 may be similar to any of the embodiment fiber coupling structures described herein, and a photonic system 400 may comprise more than one fiber coupling structure 200 in other embodiments. The fiber coupling structure 200 is utilized to receive optical signals 301 (e.g., light) from an external optical fiber 314 and redirect the optical signals 301 into a photonic die 420. In some cases, the fiber coupling structure 200 may receive optical signals from the photonic die 420 and redirect the optical signals into the external optical fiber 314. In this manner, the fiber coupling structure 200 can facilitate the coupling of optical signals between a photonic die 420 and an external optical fiber 314. The photonic system 400 is shown as an illustrative example, and a fiber coupling structure as described herein may be utilized to couple optical signals between optical fibers and any suitable photonic dies, photonic components, photonic structures, photonic devices, optical structures, waveguides, or the like. In some cases, the photonic system 400 may be considered a package, component, or the like.

In some embodiments, the fiber coupling structure 200 may be part of a fiber attachment unit 300 that facilitates connection between the fiber coupling structure 200 and an external optical fiber 314. The fiber attachment unit 300 may comprise, for example, a guide pin 302 and a lid 304 that are attached to the fiber coupling structure 200. The guide pin 302 may protrude from the fiber coupling structure 200 to facilitate attachment and alignment of an external fiber unit 310, described below. In some embodiments, multiple guide pins 302 may be used. The lid 304 may cover and protect the fiber attachment unit 300, and may comprise, for example, glass, silicon oxide, silicon, metal, plastic, molding material, another suitable material, the like, or combinations thereof. In some embodiments, the guide pin 302 has a height H4 in the range of about 600 μm to about 700 μm, though other heights are possible. In some embodiments, the lid 304 has a height H5 in the range of about 700 μm to about 1 mm, though other heights are possible. The fiber attachment unit 300 shown in FIG. 20 is an illustrative example, and other configurations or arrangements are possible.

The fiber attachment unit 300 may be configured to connect to an external fiber unit 310 that aligns and optically couples an external optical fiber 314 to the optical fiber 210 of the fiber coupling structure 200. The external fiber unit 310 may be considered a ferrule, a fiber array unit (FAU), or the like that secures and aligns the external optical fiber 314. The external optical fiber 314 comprises one or more optical fibers, and may be part of a fiber array or the like, in some cases. The external fiber unit 310 may comprise an opening 312 that corresponds to the guide pin 302, with the guide pin 302 configured to being inserted into the opening 312 when connecting the external fiber unit 310 to the fiber attachment unit 300. When the external fiber unit 310 is connected to the fiber attachment unit 300 (e.g., when the guide pin 302 is inserted into the opening 312), the external optical fiber 314 is at least approximately aligned to the optical fiber 210. In this manner, optical signals may be transmitted between the external optical fiber 314 and the optical fiber 210. In some cases, the external fiber unit 310 and/or the external optical fiber 314 may be considered part of the fiber attachment unit 300. In some embodiments, the external fiber unit 310 has a height H6 in the range of about 1.2 mm to about 1.6 mm, though other heights are possible. The external fiber unit 310 shown in FIG. 20 is an illustrative example, and other configurations or arrangements are possible.

In some embodiments, the fiber attachment unit 300 is attached to a photonic package 410 using an adhesive such as an optical glue 416 or the like. The photonic package 410 shown in FIG. 20 comprises a photonic die 420 connected to an interconnect structure 412. Other dies or components may also be connected to the interconnect structure 412 in some cases. In other embodiments, the interconnect structure 412 is not present. The photonic die 420 shown in FIG. 20 comprises an electronic die 430, in accordance with some embodiments. The electronic die 430 may be connected to photonic devices 424, described below. In accordance with some embodiments, the electronic die 430 includes integrated circuits for interfacing with the photonic devices 424, such as the circuits for controlling the operation of the photonic devices 424. For example, electronic die 430 may include controllers, drivers, amplifiers, and/or the like, or combinations thereof, and may include Serializer/Deserializer (SerDes) functionality. The corresponding components in electronic die 430 may act as parts of I/O interfaces between optical signals and electrical signals.

The photonic die 420 may include waveguides 422 such as silicon waveguides, silicon nitride waveguides, or other types of waveguides. The photonic die 420 may include photonic devices 424 such as modulators, photodetectors, laser diodes, phase shifters, or the like. For example, a photodetector may be optically coupled to the waveguides 422 to detect optical signals within the waveguides 422 and generate electrical signals corresponding to the optical signals. A modulator may be optically coupled to the waveguides 422 to receive electrical signals and generate corresponding optical signals within the waveguides 422 by modulating optical power within the waveguides 422. The photonic die 420 also comprises a reflector 426 and a coupler 425 that optically couples optical signals into the waveguides 422. For example, the reflector 426 may receive optical signals 301 from above (e.g., from the fiber coupling structure 200) and redirect those optical signals into the coupler 425, which couples the optical signals 301 into the waveguides 422. In some cases, the coupler 425 may receive optical signals from the waveguides 422 and couple them into the reflector 426, which redirects them vertically (e.g., toward the fiber coupling structure 200). In other embodiments, other coupling structures such as a grating coupler may be utilized instead of a reflector 426 and/or coupler 425. In some cases, the photonic die 420 may be considered an “optical engine” or the like.

In some cases, the photonic die 420 may comprise one or more lenses 434 formed in a support structure 432 over the reflector 426. The support structure 432 may be formed of a suitable material such as glass, silicon oxide, or another material that permits transmission of optical signals 301. The lens 434 may be vertically aligned with the underlying reflector 426 and with the overlying lens 204 of the fiber coupling structure 200. In some cases, the lens 434 may receive optical signals 301 and focus them toward the reflector 426. For example, in some embodiments, optical signals 301 within the external optical fiber 314 may be transmitted into the optical fiber 210. The optical fiber 210 may direct the optical signals 301 toward the sidewall surface 106, which reflects the optical signals 301 toward the lens 204. For example, the sidewall surface 106 having an angle (e.g., angle A1) of approximately 45° allows the sidewall surface 106 to receive optical signals 301 in a horizontal direction and reflect them into a vertical direction. In some cases, the optical signals 301 reflected into the lens 204 by the sidewall surface 106 may be collimated by the lens 204. The optical signals 301 then are transmitted through the substrate 202, through the optical glue 416, and into the photonic die 420. The optical signals 301 are transmitted to the lens 434, which reshapes or focuses the optical signals 301 into the reflector 426. The reflector 426 redirects the optical signals 301 into the coupler 425, which couples the optical signals 301 into the waveguides 422, as described previously. In this manner, optical signals may be transmitted from an external optical fiber to a photonic package using a fiber coupling structure. Optical signals may be transmitted in a similar manner from the photonic package, through a fiber coupling structure, and into an external optical fiber. The use of a fiber coupling structure as described herein can allow the connection between a photonic package and optical fiber to be more reliable, while also improving system transmission speed and efficiency.

In some cases, the photonic die 420 may be attached to an interconnect structure 412. The interconnect structure 412 may comprise a redistribution structure, an interposer, a core substrate, or the like. The photonic die 420 may be fusion bonded to the interconnect structure 412 or may be attached using conductive connectors (e.g., solder bumps) or the like, as shown in FIG. 20. The interconnect structure 412 of the photonic package 410 may be connected to a package substrate 402 using conductive connectors (e.g., solder bumps) or the like. In some embodiments, the package substrate 402 may comprise an interposer, a semiconductor substrate (e.g., a wafer), a redistribution structure, an interconnect substrate, a core substrate, a printed circuit board (PCB), or the like. In some embodiments, the fiber attachment unit 300 may be supported by a support structure 414 attached to the package substrate 402. The fiber attachment unit 300 may be attached to the support structure 414 by an optical glue 416 or other adhesive, in some cases. The system 400 of FIG. 20 is intended as a representative example of a system that incorporate a fiber coupling structure as described herein, and other systems, dies, packages, components, devices, or variations thereof may be used in other embodiments.

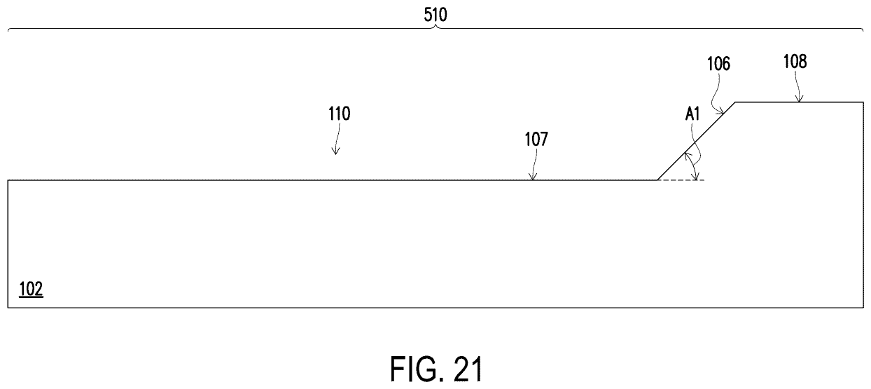

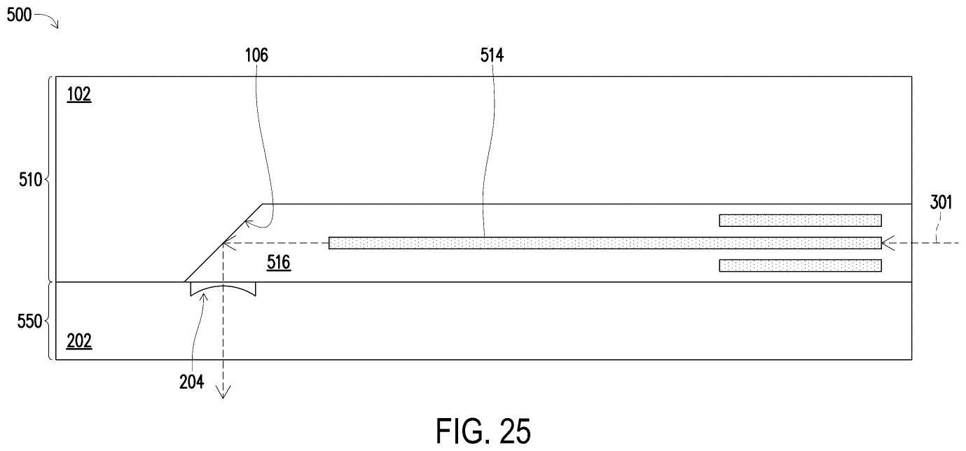

FIGS. 21 through 25 illustrate intermediate steps in the formation of a fiber coupling structure 500 (see FIG. 25), in accordance with some embodiments. The fiber coupling structure 500 is similar to the fiber coupling structure 200, except that one or more waveguides 514 are formed in the recess 110 of a mirror structure 510. In the fiber coupling structure 500, the waveguide(s) 514 are utilized to transmit optical signals (e.g., optical signals 301) rather than an optical fiber (e.g., optical fiber 210). The fiber coupling structure 200 comprises a mirror structure 510 attached to a lens structure 550, which may have some features similar to the mirror structure 100 or lens structure 220 described previously. The fiber coupling structure 500 may be incorporated in a fiber attachment unit, which may be similar to the fiber attachment unit 300 described previously.

FIGS. 21-23 illustrate intermediate steps in the formation of a mirror structure 510, in accordance with some embodiments. FIG. 21 shows a recess 110 formed in a substrate 102, in accordance with some embodiments. The structure shown in FIG. 21 may be similar to the structure shown in FIG. 4 for the mirror structure 100. For example, the structure shown in FIG. 21 comprises a substrate 102 having a bonding surface 108 and a recess 110 comprising a bottom surface 107 and a sidewall surface 106. The recess 110 may be formed using similar techniques as described previously for the mirror structure 110. For example, the recess 110 may be formed using an anisotropic etch such that the sidewall surface 106 comprises crystalline planes having an angle A1 of about 45°.

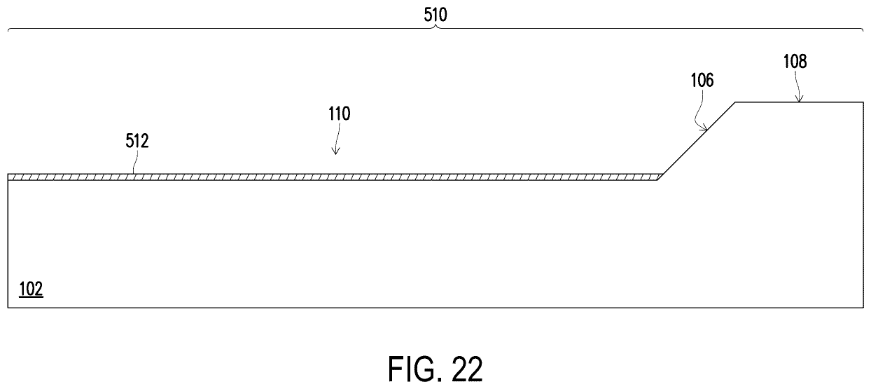

In FIG. 22, one or more reflection layers 512 are deposited over the bottom surface 107 of the mirror structure 510, in accordance with some embodiments. The reflection layers 512 on the bottom surface 107 may be formed in addition to different reflection layers 109 formed on the sidewall surface 106 described previously for FIG. 6, in some embodiments. In other embodiments, the reflection layers 512 may be formed on the bottom surface 107 and on the sidewall surface 106. The reflection layers 109 may comprise one or more layers that enhance or modify the confinement of optical signals within the subsequently formed waveguides 514. For example, the reflection layers 512 may comprise one or more metal layers and/or one or more dielectric layers. A metal reflection layer 512 may comprise, for example, gold or other suitable metals. A dielectric reflection layer 512 may comprise, for example, one or more layers of silicon oxide, silicon nitride, silicon oxynitride, or the like. Other materials or combinations of materials are possible. The reflection layers 512 may be deposited using suitable techniques, such as CVD, PVD, ALD, or the like. The reflection layers 512 are optional, and are not shown in subsequent figures.

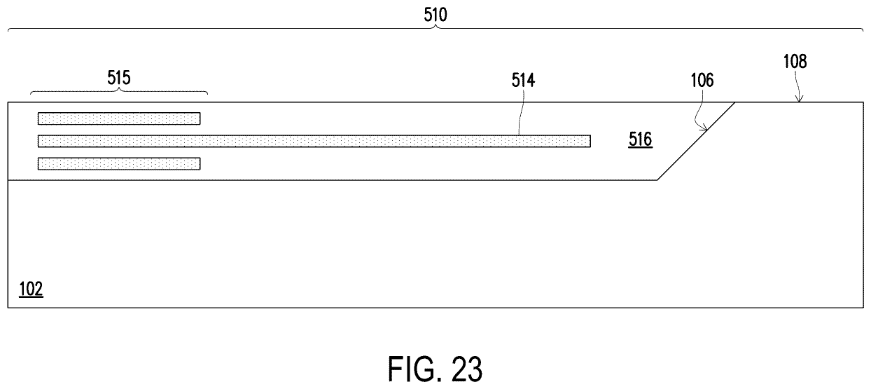

In FIG. 23, one or more waveguides 514 are formed in the recess 110, in accordance with some embodiments. The waveguides 514 allow optical signals to be transmitted to the sidewall surface 106 or received from the sidewall surface 106, and may be optically coupled to an external optical fiber (not shown) or the like. FIG. 23 shows a waveguides 514 formed within a plurality of dielectric layers 516 (not individually illustrated), however, multiple layers of waveguides 514 may be formed in other embodiments. For example, one or more layers of waveguides 514 may be formed within multiple dielectric layers 516 (not individually illustrated). In some embodiments, a waveguide 514 may be optically coupled to an adjacent waveguide 514, to an overlying waveguide 514 of another layer, and/or to an underlying waveguide 514 of another layer. In some embodiments, coupling structures 515 may also be formed within the recess 110. The coupling structures 515 may be formed using techniques similar to those used for forming the waveguides 514, and may allow optical signals to be coupled between a waveguide 514 and an external optical fiber (not shown), for example. Other optical structures, such as beam splitters, evanescent couplers, or the like, may also be formed within the recess 110.

In some embodiments, a waveguide 514 may be formed by depositing a dielectric layer 516, depositing a waveguide material on the dielectric layer 516, and then patterning the waveguide material to form the waveguide 514. Other optical structures such as couplers or beam splitters may also be formed by patterning the waveguide material, in some cases. Another dielectric layer 516 may then be deposited over the waveguide 514. This process may be repeated to form multiple layers of waveguides 514 or structures formed from multiple layers of waveguide material, such as a coupling structure 515. The waveguide material may be a dielectric material such as silicon nitride, silicon oxide, silicon oxynitride, polymer, combinations of these, or the like. In other embodiments, the waveguide material may be a semiconductor material such as silicon, germanium, silicon germanium, or the like. For example, in some embodiments, the waveguides 514 are silicon nitride waveguides formed in dielectric layers 516 of silicon oxide, though other combinations of materials are possible. The waveguide material may be deposited using a suitable technique, such as CVD, PVD, ALD, or the like. The waveguide material may be patterned using suitable photolithography and etching techniques. In some embodiments, a planarization process (e.g. a CMP process, a grinding process, or the like) may be performed on the top-most dielectric layer 516 (not individually illustrated) such that the top-most dielectric layer 516 and the bonding surface 108 are approximately level or coplanar.

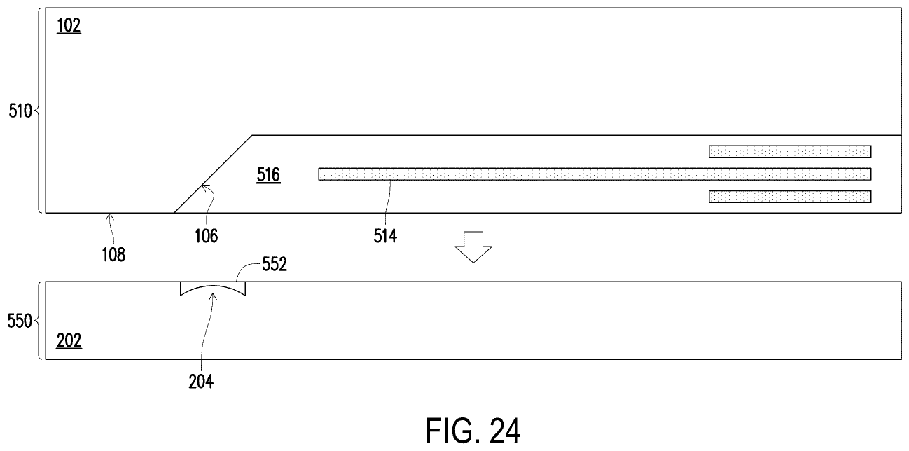

In FIGS. 24 and 25, the mirror structure 510 is attached to a lens structure 550, in accordance with some embodiments. FIG. 24 shows the mirror structure 510 prior to attachment, and FIG. 25 shows the mirror structure 510 after attachment. The lens structure 550 may be similar to the lens structure 220 shown in FIG. 12, except that no grooves for optical fibers are formed. For example, the lens structure 220 includes a lens 204 formed in a substrate 202. In some embodiments, a dielectric material 552 is formed over the lens 204. The dielectric material 552 may be similar to the material of the dielectric layers 516, in some cases. For example, the dielectric material 552 may comprise silicon oxide, though other materials are possible. In some embodiments, a planarization process (e.g. a CMP process, a grinding process, or the like) may be performed on the dielectric material 552 such that the dielectric material 552 and top surface of the substrate 202 are approximately level or coplanar.

Referring to FIG. 25, the mirror structure 510 is attached to the lens structure 550 to form the fiber coupling structure 500, in accordance with some embodiments. The mirror structure 510 may be attached to the lens structure 550 using fusion bonding (e.g., direct bonding), an adhesive, or the like. In some embodiments, the bonding surface 108 of the mirror structure 510 is attached to the top surface of the substrate 202. In some embodiments, the dielectric layers 516 may be fusion bonded to the top surface of the substrate 202 and/or the dielectric material 552. The mirror structure 510 and/or the lens structure 550 may be singulated before or after attachment. As shown in FIG. 25, optical signals 301 may be coupled into a waveguide 514 from, for example, an external optical fiber or the like. The optical signals 301 are transmitted through the waveguide 514 and directed at the sidewall surface 106, which reflects the optical signals 301 approximately 90° toward the lens 204. The lens 204 collimates or focuses the optical signals 301 towards an underlying component, such as a lens 434, reflector 426, photonic die 420, photonic package 410, or the like. Fiber coupling structures 500 having other configurations are possible.

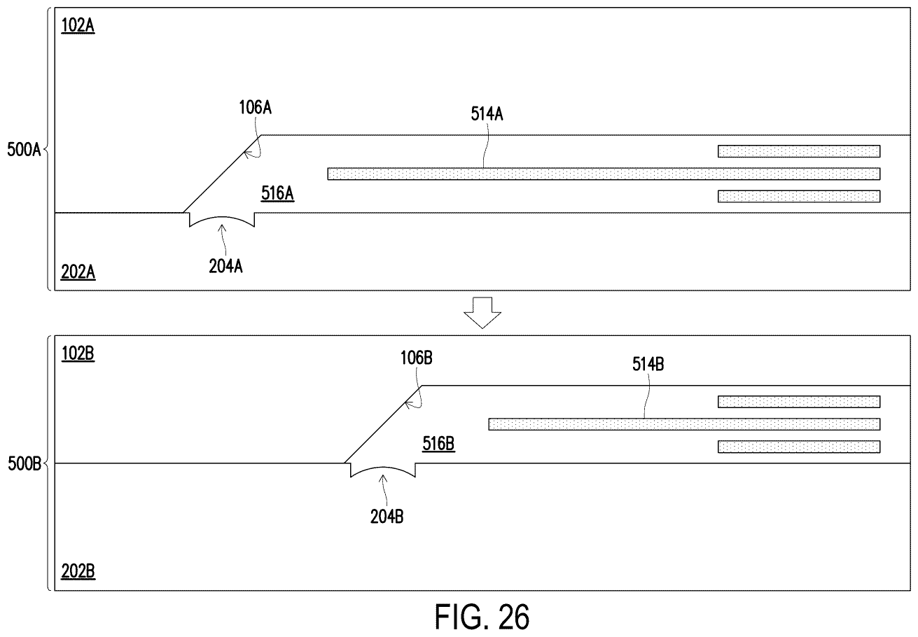

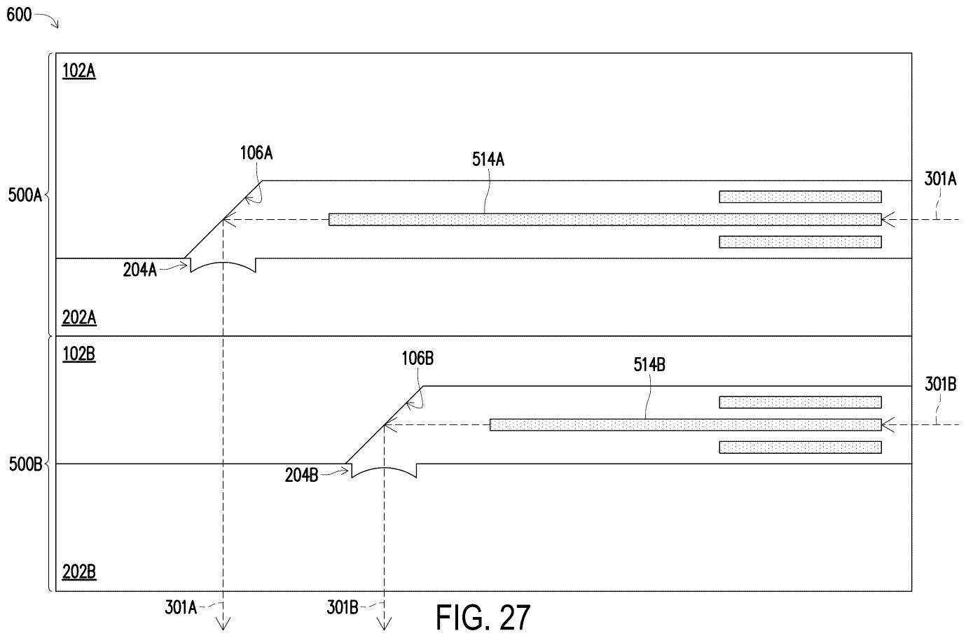

In some embodiments, multiple fiber coupling structures 500 are attached in a stack to form a fiber coupling stack. As an example, FIGS. 26 and 27 illustrate the attachment of a first fiber coupling structure 500A to a second fiber coupling structure 500B to form a multi-fiber coupling structure 600, in accordance with some embodiments. FIG. 26 shows the fiber coupling structures 500A and 500B prior to attachment. The fiber coupling structures 500A-B may be similar to the fiber coupling structure 500 described previously for FIG. 25, and may be formed using similar techniques. For example, the first fiber coupling structure 500A comprises a substrate 102A bonded to a substrate 202A, with a sidewall surface 106A formed in the substrate 102A and a lens 204A formed in the substrate 202A. The first fiber coupling structure 500A also comprises one or more waveguides 514A are formed in one or more dielectric layers 516A. The second fiber coupling structure 500B comprises a substrate 102B bonded to a substrate 202B, with a sidewall surface 106B formed in the substrate 102B and a lens 204B formed in the substrate 202B. The second fiber coupling structure 500B also comprises one or more waveguides 514B are formed in one or more dielectric layers 516B.

In FIG. 27, the substrate 202A of the first fiber coupling structure 500A is attached to the substrate 102B of the second fiber coupling structure 500B to form the multi-fiber coupling structure 600, in accordance with some embodiments. The substrate 202A may be attached to the substrate 102B using fusion bonding, an adhesive, or the like. The multi-fiber coupling structure 600 may be part of a fiber attachment unit or the like. As shown in FIG. 27, optical signals 301A may be coupled into the waveguide 514A from a first external optical fiber or the like, and optical signals 301B may be coupled into the waveguide 514B from a second external optical fiber or the like. The first optical signals 301A may be reflected by the sidewall surface 106A through the lens 204A, and the second optical signals 301B may be reflected by the sidewall surface 106B through the lens 204B. In this manner, the optical signals from multiple optical fibers may be coupled into a photonic package, photonic die, or the like by a multi-fiber coupling structure 600. The multi-fiber coupling structure 600 shown in FIG. 27 is an illustrative example, and other configurations or arrangements are possible. In other embodiments, more than two fiber coupling structures may be bonded in a stack to form a multi-fiber coupling structure 600.

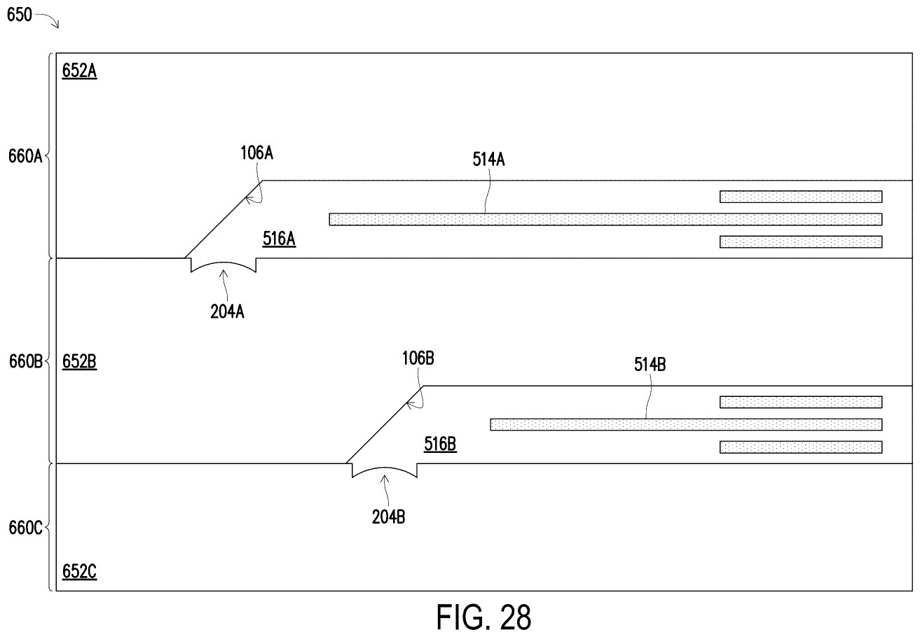

FIG. 28 illustrates a multi-fiber coupling structure 650, in accordance with some embodiments. The multi-fiber coupling structure 650 is similar to the multi-fiber coupling structure 600, except that a single substrate 652B is used instead of substrates 202A and 102B. As shown in FIG. 28, a mirror structure 660A may be formed on a substrate 652A, which may be similar to the mirror structure 510 described previously. A mirror-lens structure 660B may be formed on a substrate 652B. The mirror-lens structure 660B may be similar to the mirror structure 660A, except that a lens 204A is formed on the top side of the substrate 652B. For example, the mirror-lens structure 660B includes a sidewall surface 106B and waveguide(s) 514B formed in dielectric layers 516B. A lens structure 660C may be formed on a substrate 652C, which may be similar to the lens structure 550 described previously. To form the multi-fiber coupling structure 650, the mirror structure 660A may be attached (e.g., using fusion bonding) to the top surface of the substrate 652B, and the lens structure 660C may be attached (e.g., using fusion bonding) to the bottom surface of the substrate 652B. The multi-fiber coupling structure 650 shown in FIG. 28 is an illustrative example, and other configurations or arrangements are possible. In other embodiments, more than one mirror-lens structure may be bonded in a stack to form a multi-fiber coupling structure 6500.

The embodiments of the present disclosure have some advantageous features. The use of a silicon reflective surface in a fiber coupling structure can provide a high-precision mirror that enables 90° steering of an optical path with low optical loss. The inverted 450 reflective surfaces can be formed using semiconductor manufacturing processes such as photolithography and etching, which enables low roughness and improved reflective properties. Additionally, utilizing a flat silicon surface as a bonding surface enables good mirror bonding and mirror placement angle control. In this manner, the coupling of optical signals from optical fibers into a photonic package or photonic die may be improved.

In some embodiments of the present disclosure, a structure includes an upper silicon structure that includes a recess in a first side of the upper silicon structure, wherein the recess has a sloped sidewall; a lower silicon structure that includes a lens recessed in a first side of the lower silicon structure, wherein the first side of the upper silicon structure is bonded to the first side of the lower silicon structure, wherein the sloped sidewall of the upper silicon structure is vertically aligned with the lens of the lower silicon structure; and a waveguide structure within the recess, wherein the waveguide structure is optically coupled to the lens by the sloped sidewall. In an embodiment, the waveguide structure includes an optical fiber. In an embodiment, the waveguide structure includes a silicon nitride waveguide. In an embodiment, surfaces of the waveguide structure and the upper silicon structure are level. In an embodiment, the sloped sidewall has an angle with respect to a bottom surface of the recess that is in the range of 42.5° to 47.5°. In an embodiment, the sloped sidewall is planar. In an embodiment, the sloped sidewall is a (110) surface. In an embodiment, the sloped sidewall has a vertical height in the range of 50 μm to 300 μm. In an embodiment, the waveguide structure is attached to the recess of the upper silicon structure by an optical glue.

In some embodiments of the present disclosure, a device includes a photonic package including a first waveguide that is optically coupled to a first lens; and a fiber coupling structure attached to the photonic package, wherein the fiber coupling structure includes: a lens structure that includes a second lens that is vertically aligned to the first lens; an optical fiber attached to the lens structure; and a mirror structure attached to the lens structure, wherein the mirror structure includes a reflective surface that is laterally aligned to the optical fiber and vertically aligned to the second lens, wherein the mirror structure extends over the optical fiber. In an embodiment, the reflective surface includes a surface of crystalline silicon. In an embodiment, the reflective surface includes a reflective coating covering the surface of crystalline silicon. In an embodiment, the lens structure includes a groove adjacent the second lens, wherein the optical fiber is attached to the groove. In an embodiment, the reflective surface has a roughness less than 10 nm. In an embodiment, the optical fiber is physically separated from the mirror structure. In an embodiment, the lens structure includes a glass substrate.

In some embodiments of the present disclosure, a method includes etching a first silicon substrate to form a recess in a first surface of the first silicon substrate, wherein the recess includes a sloped sidewall; etching a second silicon substrate to form a lens in a first surface of the second silicon substrate; attaching an optical fiber to the second silicon substrate adjacent the lens; and bonding the first surface of the first silicon substrate to the first surface of the second silicon substrate, wherein the sloped sidewall is over the lens and adjacent to the optical fiber. In an embodiment, the etching includes an anisotropic etching process. In an embodiment, the method includes etching a groove in the first surface of the second silicon substrate; and placing the optical fiber in the groove. In an embodiment, bonding the first surface of the first silicon substrate to the first surface of the second silicon substrate includes fusion bonding.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A structure comprising:
an upper silicon structure comprising a recess in a first side of the upper silicon structure, wherein the recess has a sloped sidewall;
a lower silicon structure comprising a lens recessed in a first side of the lower silicon structure, wherein the first side of the upper silicon structure is bonded to the first side of the lower silicon structure, wherein the sloped sidewall of the upper silicon structure is vertically aligned with the lens of the lower silicon structure; and
a waveguide structure within the recess, wherein the waveguide structure is optically coupled to the lens by the sloped sidewall.

2. The structure of claim 1, wherein the waveguide structure comprises an optical fiber.

3. The structure of claim 1, wherein the waveguide structure comprises a silicon nitride waveguide.

4. The structure of claim 1, wherein surfaces of the waveguide structure and the upper silicon structure are level.

5. The structure of claim 1, wherein the sloped sidewall has an angle with respect to a bottom surface of the recess that is in the range of 42.5° to 47.5°.

6. The structure of claim 1, wherein the sloped sidewall is planar.

7. The structure of claim 1, wherein the sloped sidewall is a (110) surface.

8. The structure of claim 1, wherein the sloped sidewall has a vertical height in the range of 50 μm to 300 μm.

9. The structure of claim 1, wherein the waveguide structure is attached to the recess of the upper silicon structure by an optical glue.

10. A device comprising:
a photonic package comprising a first waveguide that is optically coupled to a first lens; and
a fiber coupling structure attached to the photonic package, wherein the fiber coupling structure comprises:
a lens structure comprising a second lens that is vertically aligned to the first lens;
an optical fiber attached to the lens structure; and
a mirror structure attached to the lens structure, wherein the mirror structure comprises a reflective surface that is laterally aligned to the optical fiber and vertically aligned to the second lens, wherein the mirror structure extends over the optical fiber.

11. The device of claim 10, wherein the reflective surface comprises a surface of crystalline silicon.

12. The device of claim 11, wherein the reflective surface comprises a reflective coating covering the surface of crystalline silicon.

13. The device of claim 10, wherein the lens structure comprises a groove adjacent the second lens, wherein the optical fiber is attached to the groove.

14. The device of claim 10, wherein the reflective surface has a roughness less than 10 nm.

15. The device of claim 10, wherein the optical fiber is physically separated from the mirror structure.

16. The device of claim 10, wherein the lens structure comprises a glass substrate.

17. A method comprising:
etching a first silicon substrate to form a recess in a first surface of the first silicon substrate, wherein the recess comprises a sloped sidewall;
etching a second silicon substrate to form a lens in a first surface of the second silicon substrate;
attaching an optical fiber to the second silicon substrate adjacent the lens; and
bonding the first surface of the first silicon substrate to the first surface of the second silicon substrate, wherein the sloped sidewall is over the lens and adjacent to the optical fiber.

18. The method of claim 17, wherein the etching comprises an anisotropic etching process.

19. The method of claim 17 further comprising:
etching a groove in the first surface of the second silicon substrate; and
placing the optical fiber in the groove.

20. The method of claim 17, wherein bonding the first surface of the first silicon substrate to the first surface of the second silicon substrate comprises fusion bonding.
